(19) United States
(12) Patent Application Publication
(10) Pub. No.: US 2004/0112519 A1
(43) Pub. Date: Jun. 17, 2004

(54) Process for laser welding together articles of polyester resin compositions and related products

(76) Inventor: Hiroshi Mori, Tochigi-ken (JP)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/618,042

(22) Filed: Jul. 11, 2003

Related U.S. Application Data
(60) Provisional application No. 60/395,366, filed on Jul. 12, 2002.

(51) Int. Cl. B32B 31/00

(52) U.S. Cl. 156/272.8; 428/57

(57) ABSTRACT

A process for laser welding together a laser beam transparent polyester article and a laser beam opaque polyester article. The method limits the use of a laser beam at an energy level not greater than 100 W at a scanning speed not greater than 1000 cm/min., thus causing the articles to be welded together and maintaining a high weld strength.

### CROSS REFERENCE TO RELATED APPLICATION

This application claims the benefit of U.S. Provisional Application No. 60/395,366, filed Jul. 12, 2002.

### FIELD OF THE INVENTION

Our invention relates to a process for welding together articles of thermoplastic polyester resin (both articles are made of same polyester or articles are made of different polyesters to one another), and in particular, to a process for welding together articles of thermoplastic polyester resin by applying energy with laser beams to a junction portion of the articles being positioned in contact with each other, thereby causing a junction portion of the articles to be melted and joined together.

### BACKGROUND OF INVENTION

There are various welding techniques for molded articles made from thermoplastic resins, such as hot plate welding, inductance welding, resistance welding, rotation welding, angular welding, ultrasonic welding and vibration welding. Each welding technique has advantages and disadvantage.

Recent attention has been directed to laser welding to join together two plastic articles being respectively opaque to laser beams and transparent to laser beams by positioning the two articles in contact at surfaces of the articles, transmitting a predetermined amount of laser beam focusing on the junction or interface of the surfaces, and causing the junction portion to be melted and joined together. This process is often referred to as laser welding.

For example, referring to FIG. 1, there is provided a first article 2 and a second article 3 containing a surface 4. In a typical laser welding process, the first article 2 is “transparent” to a laser beam 1, that is, the first article 2 has a high transmission rate with respect to laser beam 1; the second article 3 is “opaque” to the laser beam 1, that is, the second article 3 has a high absorption rate with respect to laser beam 1. Thus, when laser beam 1 is directed at the first article 2 and the second article 3, which are joined at surface 4, the laser beam 1 is transmitted through the first article 2 to the second article 3. Typically, the laser beam 1 traverses or scans first and second articles 2 and 3 in the direction of arrow A. The second article 3 and its surface 4 absorb the energy of laser beam 1, thereby melting the surface 4, which when pressed in contact with the first article 2, results in the first article 2 and the second article 3 being welded together.

Laser welding is useful in assembling plastic parts for various applications, for example, in manufacturing welded plastic parts for use in the automobile or electric-electronic industry. Several advantages flow from laser welding, for example, laser welding entails a simple operation, thereby often resulting in labor savings, improvements in productivity, and reduction of production costs.

As is apparent from the foregoing, laser welding of plastic articles requires the selection of both suitable transmission rate and suitable absorption rate resins.

A variety of blends of thermoplastic resin such as polyester and colorants containing an organic dye or pigment that is added to impart control of conversion of laser energy to heat in the resulting blends for use in laser welding have been proposed. See, for example, Japanese Published (Koukoku) Patent No.62-49850, and Japanese Published (Koukoku) Patent No.5 (93)-42336.

U.S. Pat. No. 5,893,959 discloses transparent and opaque work piece parts being welded together by a laser beam along a joining zone, both of the work piece parts containing black dye pigments such as carbon black to cause them to offer a substantially homogenous visual impression even after welding.

However, polyester is not always considered suitable for laser welding because of its relatively low transmission radiation in the near infrared area. This poor transmission may result in low weld strength at the junction portion of the articles.

Heretofore, however, certain conditions for laser welding polyesters have not been adequately addressed. These conditions include the laser beam transmission power, the focal length between laser beam source and the impingement location of the laser beam at the junction portion of the articles, and the transmission time of the laser beam that are necessary for making plastic articles having sufficient weld strength.

### SUMMARY OF INVENTION

The present invention is a process for laser welding together a laser beam transparent polyester article and a laser beam opaque polyester article comprising the steps of: positioning the articles in contact with each other so as to define a junction there between; transmitting a laser beam having energy not greater than 100 W focused on the area of contact at a scanning speed not greater than 1000 cm/min. thus causing the junction portion to be melted without decomposition and joining together the polyester articles.

### BRIEF DESCRIPTION OF DRAWINGS

FIG. 1 is a schematic illustration of a laser welding process.

FIG. 2 is a perspective view of a polyester test specimen for laser welding.

FIG. 3 is a graph of shear strength of welded test specimens as a function of laser power (up to about 150 W) at three different laser beam scan rates ranging from 500 to 2,000 cm/min.

FIG. 4 is a graph of shear strength of welded test specimens as a function of laser power for four different levels of colorant (BK-A) used in the laser beam transparent polyester article.

FIG. 5 is a graph of shear strength of welded test specimens as a function of laser power for two different levels of colorant (BK-B) used in the laser beam opaque polyester article.

FIG. 6 is a graph of shear strength of welded test specimens as a function of laser power for three different levels of colorant BK-A and BK-B as respectively used in the laser beam transparent article and the laser beam opaque polyester article wherein at each level of colorant the wt % BK-A=wt % BK-B.

FIG. 7 is a graph of shear strength of welded test specimens as a function of laser power (up to about 200 W) at six different laser beam scan rates ranging from 100 to 2,000 cm/min.

### DETAILED DESCRIPTION OF PREFERRED EMBODIMENTS

This invention relates to method of laser welding together a laser beam transparent polyester article and a laser beam opaque polyester article. More particularly, we have found that dynamics of the strength of the laser weld so-produced correlates with certain condition employed in the laser welding process.

“Polyester compositions” of our invention comprise at least one polyester and optionally various additives and components, as described below.

The term “polyester” as used herein preferably includes polymers having an inherent viscosity of 0.3 or greater and which are, in general, liner saturated condensation products of glycols and dicarboxylic acids, or reactive derivatives thereof. Preferably, they will comprise condensation products of aromatic dicarboxylic acids having 8 to 14 carbon atoms and at least one glycol selected from the group consisting of neopentyl glycol, cyclohexane dimethanol and aliphatic glycols of the formula HO(CH₂)ₙOH where n is an integer of 2 to 10. Up to 50 mole percent of the aromatic dicarboxylic acids can be replaced by at least one different aromatic dicarboxylic acid having from 8 to 14 carbon atoms, and/or up to 20 mole percent can be replaced by an aliphatic dicarboxylic acid having from 2 to 12 carbon atoms.

Preferred polyesters include polyethylene terephthalate; poly(1,4-butylene)terephthalate; 1,4-cyclohexylene dimethylene terephthalate/isophthalate copolymer; and other linear homopolymer esters derived from aromatic dicarboxylic acids and glycols. Preferred aromatic dicarboxylic acids include isophthalic; bibenzoic; naphthalane-dicarboxylic including the 1,5-,2,6-, and 2,7-naphthalenedicarboxylic acids; 4,4′diphenylenedicarboxylic acid; bis(p-carboxyphenyl)methane; ethylene-bis-p-benzoic acid; 1,4-tetramethylene bis(p-oxybenzoic)acid; ethylene bis(p-oxybenzoic)acid; and 1,3-trimethylene bis(p-oxybenzoic)acid. Preferred glycols include those selected from the group consisting of 2,2-dimethyl-1,3-propane diol; neopentyl glycol; cyclohexane dimethanol; and aliphatic glycols of the general formula HO(CH₂)ₙOH where n is an integer from 2 to 10, e.g., ethylene glycol; 1,3-trimethylene glycol; 1,4-tetramethylene glycol; 1,6-hexamethylene glycol; 1,8-octamethylene glycol; 1,10-decamethylene glycol; 1,3-propylene glycol; and 1,4-butylene glycol. Up to 20 mole percent, as indicated above, of preferably adipic, sebacic, azelaic, dodecanedioic acid or 1,4-cyclohexanedicarboxylic acid can be present.

The most preferred polyester compositions of our invention are based on polyethylene terephthalate homopolymers, polybutylene terephthalate homopolymers, polyethylene terephthalate/polybutylene terephthalate copolymers, polyethylene terephthalate copolymers, polyethylene terephthalate/polybutylene terephthalate mixtures and/or mixtures thereof, although any other polyesters can be used as well, either alone or in any combination with any of the polyesters described herein.

The polyester compositions of our invention may contain nucleating agent(s) preferably in an amount of up to 1 wt %, more preferably in an amount of up to 0.7 wt %, and even more preferably up to 0.4 wt %, based on the total weight of the polyester composition.

Conventional additives may be added to the polyester compositions of our invention. For instance, a flame retardant and flame-retardant auxiliary may be added for the purpose of improving flame retardancy, and an antioxidant and heat stabilizer may be added for the purpose of improving heat resistance and preventing discoloration. Other additives include fillers, reinforcing agents, impact modifiers, viscosity modifiers, lubricants, plasticizers, mold-releasing agents, and UV stabilizers.

Laser beam transparent polyester compositions of the invention (hereinafter defined) may contain a black colorant to offer a substantially homogeneous visual impression even after welding. This is commonly done in, for example, automotive applications, so as to have in an article molded therefrom the same color of black as that of the laser beam opaque polyester part that includes laser beam absorbing colorants, such as carbon black and nigrosine. This allows the resulting laser welded part to have a uniform black appearance. The preferred amount of black colorants is preferably 0.01 to 1% by weight of the polyester composition. The amount of the colorants also may be determined by applications requiring different properties associated with the laser welding.

The black colorant preferably shows absorption in the visible light region (400-700 nm) and exhibits a transmission property from the diode laser to the near YAG laser area (800-1200 nm). All dyes that show partial absorption in the visible light region (400-700 nm) and have transmitting property from the diode laser to the near YAG laser area (800-1200 nm) can be used as the aforementioned black colorant. As an example, blending two or more dyes of the black dyes having a single structure for absorption in the visible light region to give a mixed black color dye having absorption in the visible light region may be cited.

As preferred examples of the dyes for application in the black colorant for the laser beam transparent article, monoazo metal dyes, anthraquinone dyes, perinone dyes and quinophthalone dyes can be cited. Each can be used alone or in any combination with the others.

Polyester compositions of our invention can be obtained by blending all of the component materials using any blending method. These blending components in general are preferably made homogeneous as much as possible. As a specific example, all of the component materials are mixed to homogeneity using a mixer such as a blender, kneader, Banbury mixer, roll extruder, etc. to give a resin composition. Or, part of the materials may be mixed in a mixer, and the rest of the materials may then be added and further mixed until homogeneous. Alternatively, the materials may be dry-blended in advance, and a heated extruder is then used to melt and knead until homogeneous, and then to extrude in a needle shape, followed by cutting to a desirable length to become granulates.

Molding of the polyester compositions of our invention into articles can be carried out according to methods known to those skilled in the art. Preferred are generally utilized molding methods such as injection molding, extruding molding, pressing molding, foaming molding, blow molding, vacuum molding, injection blow molding, rotation molding, calendar molding and solution casting molding.

Our invention includes a process for laser welding together a laser beam transparent polyester article and a laser beam opaque polyester article comprising the steps of positioning the articles in contact with each other so as to define a junction there between; transmitting a laser beam energy not greater than 100 W focused on the area of contact at a scanning speed not larger than 1000 cm/min, preferably 300 cm/min; causing the junction portion to be melted without decomposition and joining together the polyester articles.

According to the invention, weld strength of the articles made of thermoplastic polyester joined at said junction portion under the aforementioned conditions is relatively high as representative of shear strength not less than 20 MPa under shear speed of 2 mm/min, and varies responsively to laser beam power to be applied to the junction portion of the articles.

In case that the thickness of the polyester articles are changed, changes in operating conditions are usually required. It is often used to increase laser power or reduce laser scanning speed when thickness of the parts is increased, and contrary it is often used to reduce laser power or increase laser scanning speed when the thickness of the parts gets thinner.

Preferably, a laser welded article comprises at least one plastic part having a suitable absorption rate for use in laser welding (the “absorption part” or “laser bean opaque article”) and at least one plastic part made from a polyester composition selected by the above-described most common polyester molding composition (the “transmission part” or “laser beam transparent article”). Any “absorption part” may be laser welded to any “transmission part” at one or more interfaces and can be made of same polyester as the transmission part or a different polyester from that of the transmission part. More preferably, the laser welded article comprises more than one “absorption part” and more than one “transmission part” and a multiplicity of interfaces or junctions among the parts, that is, any part may be laser welded to any other part or parts at one or more interfaces. The parts, of course, may be different in shape, size, dimension, and compositions.

When the laser beam transparent part and absorption parts were welded together under relatively higher power not less than 100 W, it was found that the preferable weight percentage of colorant for the absorption part was more than 0.15 wt % in case of carbon black as a black colorant and more than 1.0 wt % in case of Nigrosine as a black colorant. Preferably, a plastic part having a suitable absorption rate is a part made from a polyester composition and preferably absorbs any laser having a wavelength within the range of 800 nm to 1200 nm.

The preferred laser for use in making laser welded articles of our invention is any laser having a wavelength within the range of 800 nm to 1200 nm. Particularly preferred lasers are described in the Examples.

### EXAMPLES

The following examples illustrate preferred embodiments of our invention; our invention is not limited to these examples.

Components used in the examples are identified as follows:

PET1: 30% glass reinforced PET by mixing the following components; a) polyethylene terephthalate from terephthalic acid and ethylene glycol the intrinsic viscosity of which is 0.85 when measured at 25° C. as a 1% solution in a mixed solution of phenol and dichlorobenzene with the weight ratio of 1/1, b) Antioxidant: Irganox 1010 (tradename) produced by Ciba Geigy Co. and c) Glass fiber: Chopped glass fiber PPG 3563 (tradename) produced by PPG Co.

PET2: 30% glass reinforced PET by mixing the following components; a) polyethylene terephthalate from terephthalic acid and ethylene glycol the intrinsic viscosity of which is 0.78 when measured at 25° C. as a 1% solution in a mixed solution of phenol and dichlorobenzene with the weight ratio of 1/1, b) Antioxidant: Irganox 1010 (tradename) produced by Ciba Geigy Co., c) Glass fiber: Chopped glass fiber PPG 3563 (tradename) produced by PPG Co., d) Nucleating agent: Sodium salt (Himilan®, produced by Mitsui-DuPont Polychemical K.K.) and e) Plasticizer: Lionon DEH40(tradename) produced by Lion K. K.

PBT: polybutylene terephthalate from terephthalic acid and 1,4-butanediol the intrinsic viscosity of which is 0.85 when measured at 25° C. as a 1% solution in a mixed solution of phenol and dichlorobenzene with the weight ratio of 1/1, b) Antioxidant: Irganox 1010 (tradename) produced by Ciba Geigy Co. and c) Glass fiber: Chopped glass fiber PPG 3563 (tradename) produced by PPG Co.

Carbon black: 30% black masterbatch diluted with polyethylene produced by Cabot Corp.

Nigrosine: 50% black masterbatch diluted with polyethylene

Percentage of black colorants shown in Tables 1 and 2, below, are described with weight percent, unless otherwise indicated.

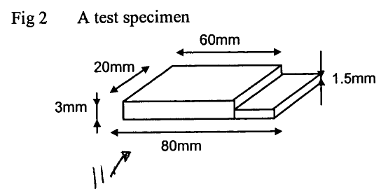

The mixtures shown below in Tables 1 and 2 were blended, and were injection-molded into both test bars 11 having the overall shape shown in FIG. 2. The dimensions of the bar are as follows: the overall thickness of the specimen is 3 mm with a decrease to 1.5 mm to define a step; the overall length of the specimen is 80 mm with a 20 mm length defining the step; and the overall width of the specimen is 20 mm. The injection molding of the specimens was carried out using an injection-molding machine, designated as Netstal Sycapl65/75, manufactured by Sumitomo. The melting temperature was 290° C. for PET and 270° C. for PBT, and the mold temperature was 100° C. for PET and 80° C. for PBT respectively.

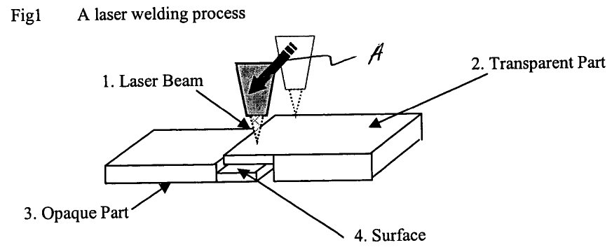

Molded test specimens of Examples 1-12 were laser-welded with using a diode laser on DLx50S (940nm, beam diameter at focus: 3 mm, maximum power 500 W) by Rofin-Sinar as schematically illustrated in FIG. 1.

The tensile shear strength of the welded test pieces, under shear speed of 2 mm/min, was measured on AG20 kND by Shimadzu Seisakusho.

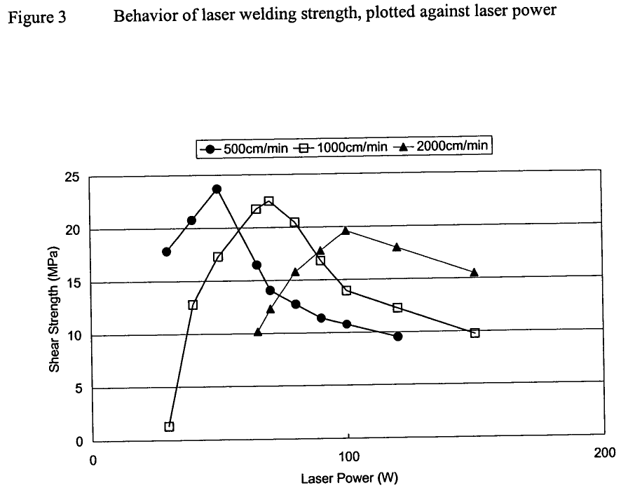

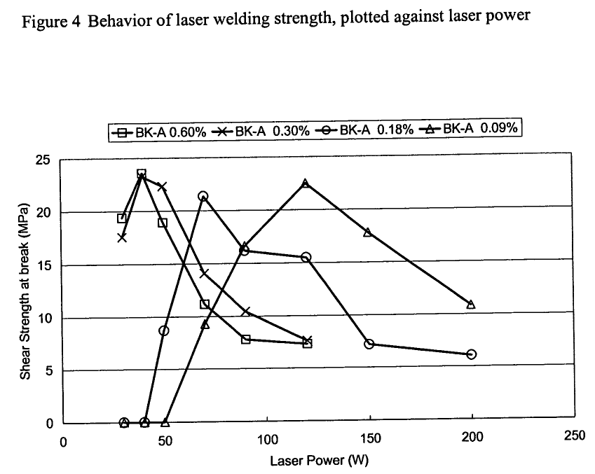

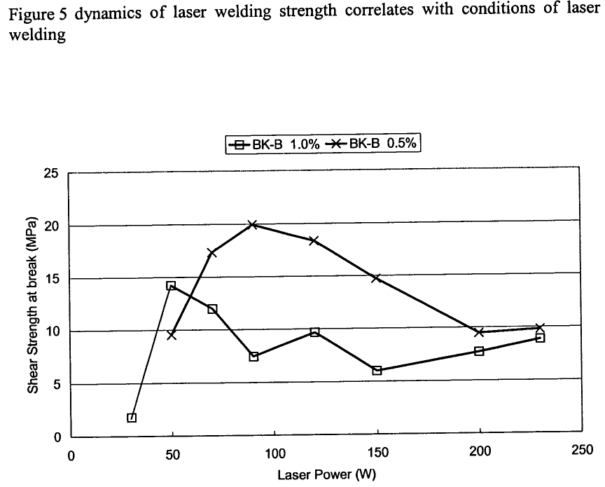

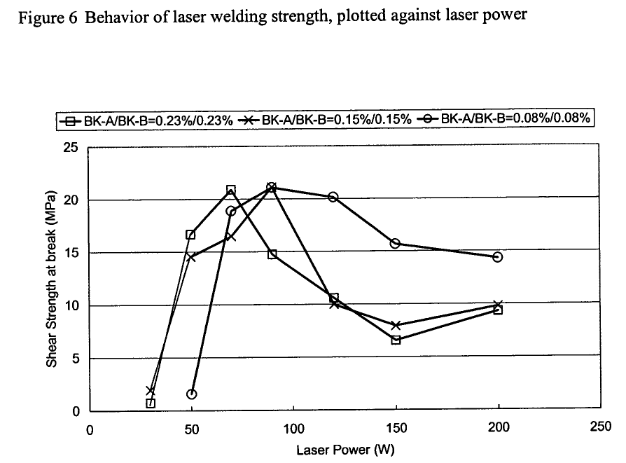

Collected shear strength data under several welding conditions for the resins listed in Table 2 were potted in FIGS. 3-6. From FIGS. 3-6, the maximum value of weld strength for each example listed in Table 2 and the laser power ranges that resulted in a weld that maintained at lease 80% of peak strength were observed. The results are also included in Table1 and 2 as E and I, respectively.

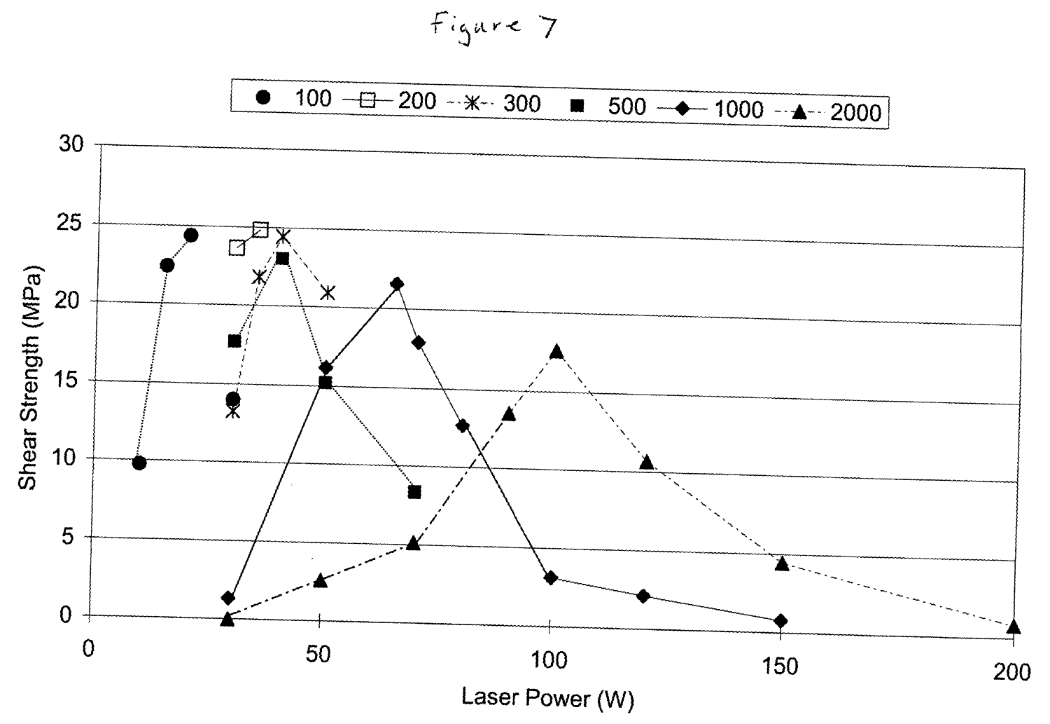

FIG. 7 illustrates the desirability of maintaining the laser beam energy at a level not greater than 100 W and at a scanning speed not greater than 1000 cm/min in order to maintain high weld strength.

In the Table 1 below, the column labeled “BK colorant type and content for BK %” designates the type of black colorant and the weight percent in the polyester composition, BK-A is carbon black as defined above.

It can be see from the data in Table 1 and FIG. 3 that as laser beam power and the scanning speed decrease, the weld strength is relatively high.

TABLE 1
Examples of laser welding strength measurement

| | | | C | | | | G | H | |
|---|---|---|---|---|---|---|---|---|---|
| | | | BK | | | F | Min. power | Max. power | I |
| | | | Colorant | D | E | Power | to maintain | to maintain | Deviation |
| | A | B | Type and | Scanning | Peak | at peak | 80% of | 80% of | (G) |
| | Transparent | Absorption | Content for | speed | strength | strength | peak strength | peak strength | and |
| Example | Material | Material | (B) % | Cm/min | MPa | (E) | (F) | (F) | (H) |
| 1 | PET1 | PET2 | BK-A: | 500 | 23.7 | 50 | 33 | 60 | 27 |
| | | | 0.60 | | | | | | |
| 2 | PET1 | PET2 | BK-A: | 1000 | 21.6 | 70 | 52 | 87 | 35 |
| | | | 0.60 | | | | | | |
| 3 | PET1 | PET2 | BK-A: | 2000 | 19.6 | 100 | 80 | 147 | 67 |
| Comparative | | | 0.60 | | | | | | |

In Table 2 below, the column labeled “BK colorant type and content for BK %” designates the type of black colorant and the weight percent in the polyester composition, BK-A is carbon black; BK-B is nigrosine as defined above.

TABLE 2
Examples for laser welding strength measurement

| | | | C | | | | G | H | |
|---|---|---|---|---|---|---|---|---|---|
| | | | BK | | | F | Min. power | Max. power | I |
| | | | Colorant | D | E | Power | to maintain | to maintain | Deviation |
| | A | B | Type and | Scanning | Peak | at peak | 80% of | 80% of | (D) |
| | Transparent | Absorption | Content for | speed | strength | strength | peak strength | peak strength | and |
| Example | Material | Material | (B) % | cm/min | MPa | (B) | (C) | (C) | (E) |
| 4 | PET1 | PBT | BK-A: | 500 | 22.5 | 120 | 97 | 149 | 52 |
| Comparative | | | 0.09 | | | | | | |
| 5 | PET1 | PBT | BK-A: | 500 | 21.4 | 70 | 63 | 86 | 23 |
| | | | 0.18 | | | | | | |
| 6 | PET1 | PBT | BK-A: | 500 | 23.2 | 40 | 32 | 60 | 28 |
| | | | 0.30 | | | | | | |
| 7 | PET1 | PBT | BK-A: | 500 | 23.5 | 40 | 30 | 50 | 20 |
| | | | 0.60 | | | | | | |
| 8 | PET1 | PBT | BK-B: | 500 | 19.9 | 90 | 67 | 139 | 72 |
| | | | 0.50 | | | | | | |
| 10 | PET1 | PBT | BK-A: | 500 | 21.1 | 90 | 68 | 142 | 74 |
| | | | BK-B = 0.08:0.08 | | | | | | |
| 11 | PET1 | PBT | BK-A: | 500 | 21.1 | 90 | 72 | 101 | 29 |
| | | | BK-B = 0.15:0.15 | | | | | | |
| 12 | PET1 | PBT | BK-A: | 500 | 21.0 | 70 | 50 | 84 | 34 |
| | | | BK-B = 0.23:0.23 | | | | | | |

The above results clearly demonstrate the amount of black colorant contained in the polyester composition for making a laser beam opaque article affects the weld strength. As can be seen from the data above, polyester composition containing less than 0.15 wt % carbon black or less than 0.6wt % nigrosine or a mixture thereof of this invention improve the weld strength relative to the comparative examples (Examples 5,6, 7, 9 11, and 12).

While our invention has been described with respect to what is at present considered to be the preferred embodiments, it is to be understood that our invention is not limited to the disclosed embodiments. To the contrary, our invention is intended to cover various modifications and equivalent arrangements included within the spirit and scope of the appended claims. The scope of the following claims is to be accorded the broadest interpretation so as to encompass all such modifications and equivalent formulations and functions.

We claim:

1. A process for laser welding together a laser beam transparent polyester article and a laser beam opaque polyester article comprising the steps of positioning the articles in contact with each other so as to define a junction there between; transmitting a laser beam energy not greater than 100 W focused on the area of contact at a scanning speed not greater than 1000 cm/min thus causing the junction to be melted without decomposition and joining together the polyester articles.

2. A process in accordance with claim 1 wherein the laser beam energy is not greater than 100 W and focused on the area of contact at a scanning speed not greater than 300 cm/min.

3. A process in accordance with claim 1 wherein the laser beam energy is not lager than 70 W and focused on the area of contact at a scanning speed not larger than 300 cm/min.

4. A process in accordance with claim 1 wherein said laser beam transparent polyester article and said laser beam opaque polyester article are made from polyester compositions selected from the group consisting of polyethylene terephtalate and polybutylene terephtalate and the polyesters of the of the laser beam transparent article and the laser beam opaque article are different.

5. A process in accordance with claim 1 wherein said laser beam transparent polyester article and said laser beam opaque polyester article are both made from polyester compositions selected from the group consisting of polyethylene terephtalate and polybutylene terephtalate and the polyesters of the laser beam transparent article and the laser beam opaque article are different.

6. A process in accordance with claim 4 wherein said laser beam opaque polyester article includes 0.15 wt % carbon black based on a total weight of the polyester composition in the article.

7. A process in accordance with claim 4 wherein said laser beam opaque polyester article includes 1.0 wt % nigrosine dye based on a total weight of the polyester composition in the article.

8. A process according to claim 4, wherein a mixture of carbon black and nigrosine is contained in polyester composition of said laser beam opaque polyester article.

9. A laser welded article of manufacture made from the laser welding process of claim 1.
